(19) United States
(12) Patent Application Publication
(10) Pub. No.: US 2010/0257014 A1
(43) Pub. Date: Oct. 7, 2010

(54) EVENT SCHEDULING

(75) Inventors: Brian F. Roberts, Dallas, TX (US); Heath Stallings, Colleyville, TX (US); Donald H. Relyea, JR., Dallas, TX (US)

Correspondence Address: VERIZON;PATENT MANAGEMENT GROUP, 1320 North Court House Road, 9th Floor, ARLINGTON, VA, 22201-2909, US

(73) Assignee: VERIZON PATENT AND LICENSING INC., Basking Ridge, NJ (US)

(21) Appl. No.: 12/416,401

(22) Filed: Apr. 1, 2009

(51) Int. Cl. G06Q 10/00; G06F 3/041

(52) U.S. Cl. 705/9; 345/173

(57) ABSTRACT

A device includes a memory to store multiple instructions, a display, and a processor. The processor executes instructions in the memory to receive a user input to associate two or more contacts with an event object, retrieve scheduling information for each of the two or more contacts, and present, on the display, a calendar presentation and the event object located within the calendar presentation. The processor further executes instructions in the memory to receive a user input to move the event object to multiple locations within the calendar presentation, where each of the locations of the event object within the calendar presentation is associated with a different time period, and present an indication of the availability of each of the two or more contacts for each time period associated with the position of the event object.

### BACKGROUND

Mobile devices (e.g., cell phones, personal digital assistants (PDAs), etc.) are being configured to support an increasing amount and variety of applications. For example, a mobile device may include telephone applications, organizers, email applications, instant messaging (IM) applications, games, cameras, image viewers, etc. Mobile devices may connect with other devices to obtain scheduling/calendar information of other people. The scheduling information may be used to schedule meetings/events for groups of proposed attendees. However, it is extremely difficult to display overlapping schedules of proposed attendees in a usable way to determine availability for a meeting/event.

### BRIEF DESCRIPTION OF THE DRAWINGS

FIG. 1 is a diagram illustrating an exemplary implementation of an event scheduling interface;

FIG. 2 depicts a diagram of an exemplary device in which systems and/or methods described herein may be implemented;

FIG. 3 depicts a diagram of exemplary components of the device illustrated in FIG. 2;

FIG. 4 depicts a diagram of exemplary functional components of the device illustrated in FIG. 2;

FIGS. 5A-5F illustrate exemplary scheduling operations capable of being performed by the device depicted in FIG. 2;

FIG. 6 depicts a flow chart of an exemplary process for providing scheduling object according to implementations described herein;

FIG. 7 provides an illustration of an exemplary implementation of a quick-access menu on a mobile device; and

FIG. 8 provides an illustration of another exemplary implementation of a quick-access menu on a mobile device.

### DETAILED DESCRIPTION OF PREFERRED EMBODIMENTS

The following detailed description refers to the accompanying drawings. The same reference numbers in different drawings may identify the same or similar elements. Also, the following detailed description does not limit the invention.

Systems and/or methods described herein may provide an event scheduling interface to enable a user to easily identify availability of potential attendees. An event object may be provided with attendee dependencies. User input, such as a touch on a touch-sensitive screen, may be applied to move the event object over a calendar or another time-based representation. Indicators (e.g., icons, images, etc.) of potential attendees may show the availability of each attendee during the time period within the calendar where the event object rests. Thus, availability of the potential attendees may be indicated in real-time by “dragging” the event object over different time periods on the calendar representation.

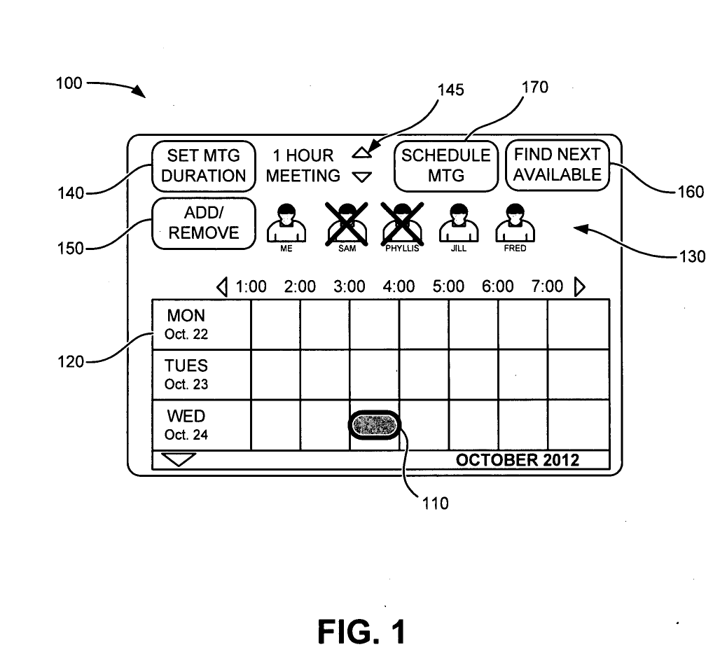

FIG. 1 provides a diagram illustrating an exemplary implementation of an event scheduling interface 100. Event scheduling interface 100 may include event object 110, calendar 120, representations 130, set meeting duration icon 140, add/remove attendee icon 150, find next available icon 160, and schedule meeting icon 170. Event object 110 may represent a proposed event (e.g., meeting) that may be moved along a calendar 120. Calendar 120 may be any representation that permits time-based scheduling. Representations 130 (individually referred to herein as “representation 130”) of potential attendees may be used to indicate the availability of potential attendees for a time period corresponding to the location of event object 110 on calendar 120.

Event object 110 may represent a particular duration (e.g., one hour) that may be defined by the user. For example, set meeting duration icon 140 may provide a menu from which a user may select a particular duration (e.g., 30 minutes, 1 hour, half-day, etc.). In another implementation, the duration of event object 110 may be adjusted using incremental controls, such as incremental controls 145, or other user interface techniques. Event object 110 may be associated with schedules of the potential attendees indicated by representations 130. For example, a user may select add/remove attendee icon 150 which may provide a menu from which a user may select contacts to add to the group of potential attendees. Each potential attendee may have a separate representation 130. Event scheduling interface 100 may also optionally include a find next available icon 160. Find next available icon 160 may provide a user with a recommendation of the earliest time period (relative to a current time period) without conflicts available to all potential attendees. Schedule meeting icon 170 may also be optionally included to automatically initiate a meeting invitation for potential attendees at a time period selected by the user.

In the exemplary implementation of FIG. 1, event object 110 is shown having a one-hour duration with dependencies to five potential attendees (i.e., “ME,” “SAM,” “PHYLLIS,” “JILL” and “FRED”) indicated by representations 130. Event object 110 is located at the time period of Wednesday, October 24^{th} from 3:00-4:00. For this time period, representations 130 indicate that two of the five potential attendees (i.e., “SAM” and “PHYLLIS”) are not available during all or part of the time period. Thus, a user may choose, for example, to move event object 110 to a different location on calendar 120 to identify another time period where all of the potential attendees are available.

Although FIG. 1 shows an exemplary event scheduling interface 100, in other implementations, event scheduling interface 100 may contain fewer, different, differently arranged, or additional items than depicted in FIG. 1. For example, controls and/or definitions for event object 110 can be included on a separate interface screen or fully integrated on a single interface screen. Also, calendar 120 may be presented in a different arrangement to display more or fewer time intervals. Furthermore, calendar 120 may be presented as a linear timeline or another time-based representation.

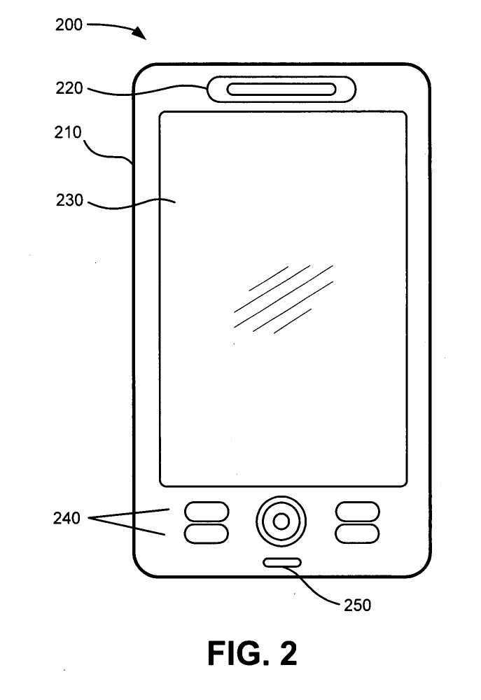

FIG. 2 is a diagram of an exemplary device 200 in which systems and/or methods described herein may be implemented. Device 200 may include a radiotelephone, a personal communications system (PCS) terminal (e.g., that may combine a cellular radiotelephone with data processing and data communications capabilities), a PDA (e.g., that can include a radiotelephone, a pager, Internet/intranet access, etc.), a portable gaming system, a personal computer, a laptop computer, and/or any other device capable of utilizing a touch screen display.

As illustrated in FIG. 2, device 200 may include a housing 210, a speaker 220, a display 230, control buttons 240, and/or a microphone 250. Housing 210 may protect the components of device 200 from outside elements. Housing 210 may include a structure configured to hold devices and components used in device 200, and may be formed from a variety of materials. For example, housing 210 may be formed from plastic, metal, or a composite, and may be configured to support speaker 220, display 230, control buttons 240 and/or microphone 250.

Speaker 220 may provide audible information to a user of device 200. Speaker 220 may be located in an upper portion of device 200, and may function as an ear piece when a user is engaged in a communication session using device 200. Speaker 220 may also function as an output device for music and/or audio information associated with games and/or video images played on device 200.

Display 230 may provide visual information to the user. For example, display 230 may display text input into device 100, text, images, video, and/or graphics received from another device, and/or information regarding incoming or outgoing calls or text messages, emails, media, games, phone books, address books, the current time, etc. For example, display 230 may include a liquid crystal display (LCD), such as a thin film transistor (TFT) LCD, etc.

In one implementation, display 230 may include a touch screen display that may be configured to receive a user input when the user touches (or comes in close proximity to) display 230. For example, the user may provide an input to display 230 directly, such as via the user's finger, or via other devices, such as a stylus. User inputs received via display 230 may be processed by components and/or devices operating in device 200. The touch-screen-enabled display 230 may permit the user to interact with device 200 in order to cause device 200 to perform one or more operations. Exemplary technologies to implement a touch screen on display 230 may include, for example, a near-field-sensitive (e.g., capacitive) overlay, an acoustically-sensitive (e.g., surface acoustic wave) overlay, a photo-sensitive (e.g., infra-red) overlay, a pressure sensitive (e.g., resistive and/or capacitive) overlay, and/or any other type of touch panel overlay that allows display 230 to be used as an input device. The touch-screen-enabled display 230 may also include the ability to identify movement of a body part or a pointing device as it moves on or near the surface of the touch-screen-enabled display 230.

Control buttons 240 may permit the user to interact with device 200 to cause device 200 to perform one or more operations. For example, control buttons 240 may be used to cause device 200 to transmit information and/or to activate event scheduling interface 100 on display 230. Microphone 250 may receive audible information from the user. For example, microphone 250 may receive audio signals from the user and may output electrical signals corresponding to the received audio signals.

Although FIG. 2 shows exemplary components of device 200, in other implementations, device 200 may contain fewer, different, differently arranged, or additional components than depicted in FIG. 2. For example, in some implementations device 200 may include a keypad, such as a standard telephone keypad, a QWERTY-like keypad (e.g., a traditional configuration of typewriter or computer keyboard keys), or another keypad layout. In still other implementations, a component of device 200 may perform one or more tasks described as being performed by another component of user device 200.

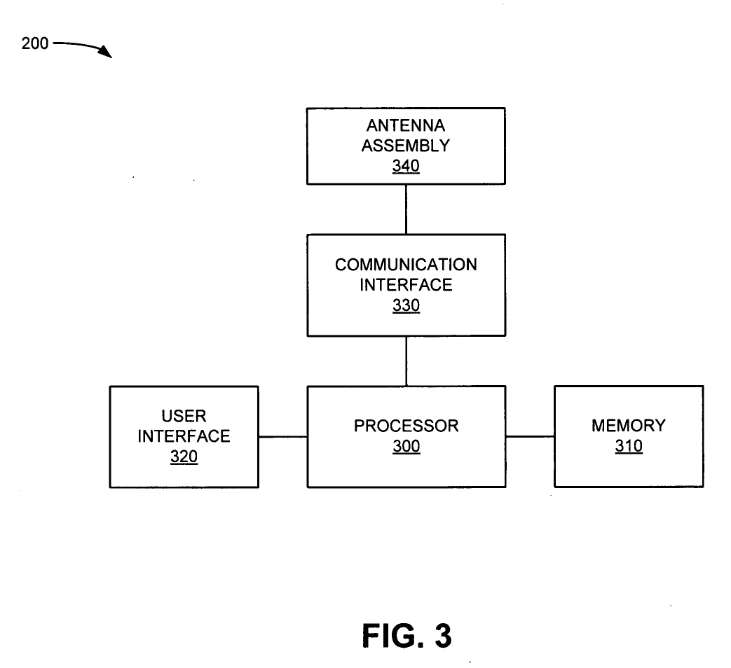

FIG. 3 is a diagram of exemplary components of device 200. As illustrated, device 200 may include a processor 300, a memory 310, a user interface 320, a communication interface 330, and/or an antenna assembly 340.

Processor 300 may include one or more microprocessors, application specific integrated circuits (ASICs), field programmable gate arrays (FPGAs), or the like. Processor 300 may control operation of device 200 and its components. In one implementation, processor 300 may control operation of components of device 200 in a manner described herein.

Memory 310 may include a random access memory (RAM), a read-only memory (ROM), and/or another type of memory to store data and instructions that may be used by processor 300. In one implementation, memory 310 may store data used to display a graphical user interface, such as quick-access menu arrangement 100 on display 230.

User interface 320 may include mechanisms for inputting information to device 200 and/or for outputting information from device 200. Examples of input and output mechanisms might include buttons (e.g., control buttons 240, keys of a keypad, a joystick, etc.); a speaker (e.g., speaker 220) to receive electrical signals and output audio signals; a microphone (e.g., microphone 250) to receive audio signals and output electrical signals; a display (e.g., display 230) to receive touch input and/or to output visual information; a vibrator to cause device 200 to vibrate; and/or a camera to receive video and/or images.

Communication interface 330 may include, for example, a transmitter that may convert baseband signals from processor 300 to radio frequency (RF) signals and/or a receiver that may convert RF signals to baseband signals. Alternatively, communication interface 330 may include a transceiver to perform functions of both a transmitter and a receiver. Communication interface 330 may connect to antenna assembly 340 for transmission and/or reception of the RF signals.

Antenna assembly 340 may include one or more antennas to transmit and/or receive RF signals over the air. Antenna assembly 340 may, for example, receive RF signals from communication interface 330 and transmit them over the air, and receive RF signals over the air and provide them to communication interface 330. In one implementation, for example, communication interface 330 may communicate with a network and/or devices connected to a network.

As will be described in detail below, device 200 may perform certain operations described herein in response to processor 300 executing software instructions of an application contained in a computer-readable medium, such as memory 310. A computer-readable medium may be defined as a physical or logical memory device. A logical memory device may include a space within a single physical memory device or spread across multiple physical memory devices. The software instructions may be read into memory 310 from another computer-readable medium or from another device via communication interface 330. The software instructions contained in memory 310 may cause processor 300 to perform processes that will be described later. Alternatively, hardwired circuitry may be used in place of or in combination with software instructions to implement processes described herein. Thus, implementations described herein are not limited to any specific combination of hardware circuitry and software.

Although FIG. 3 shows exemplary components of device 200, in other implementations, device 200 may contain fewer, different, differently arranged, or additional components than depicted in FIG. 3. In still other implementations, a component of device 200 may perform one or more other tasks described as being performed by another component of device 200.

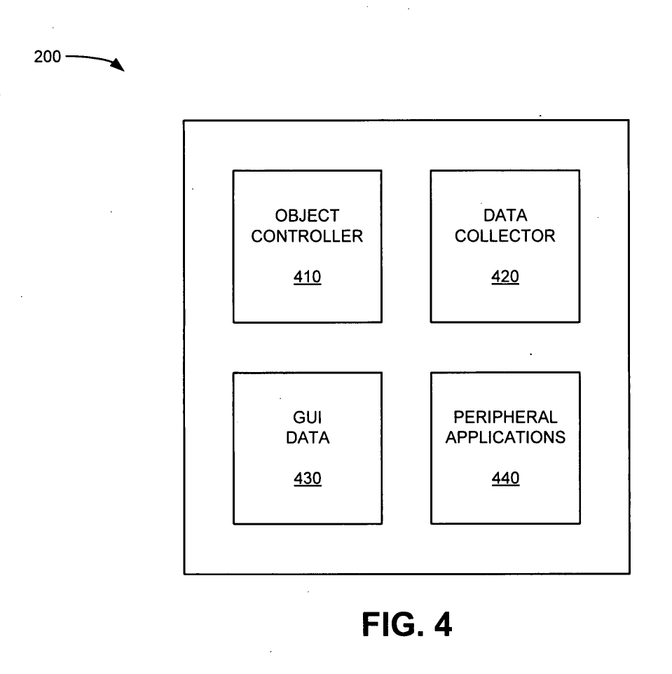

FIG. 4 provides a diagram of exemplary functional components of device 200. As shown in FIG. 4, device 200 may include object controller 410, data collector 420, and graphic user interface (GUI) data 430. Device 200 may also include other peripheral applications 440 that provide communication, organizational, and other services for device 200. In one implementation, functions of object controller 410, data collector 420, GUI data 430, and peripheral applications 440 may be implemented by processor 300 in conjunction with memory 310.

Object controller 410 may generate and update an event object (e.g., event object 110) that links an event (e.g., a meeting) duration with scheduled availability for potential attendees. In one implementation, object controller 410 may receive user input to define an event duration and to define potential attendees for the event. Object controller 410 may retrieve (e.g., from data collector 420) schedule information for each of the potential attendees. Object controller 410 may receive user input to position the event object on a calendar display and may calculate the availability of each of the potential attendees in relation to the position of the event object on the calendar display.

Object controller 410 may identify basic information about each potential attendee (e.g., a graphic, such as an image, associated with the attendee that may be associated with one of peripheral applications 440) and create a contact-related graphic (e.g., representation 130) for each potential attendee based on the basic information. In one implementation, object controller 410 may assemble icons and/or graphics based on one or more templates retrieved from GUI data 430. Templates may include, for example, arrangements for calendars/timelines (e.g., calendar 120) upon which the event object may appear to exist, defined locations for contact-related graphics, and/or other user-input buttons (e.g., set meeting duration icon 140, add/remove attendee icon 150, find next available icon 160, schedule meeting icon 170, etc.). Object controller 410 may also provide signals to alter the display of contact-related graphics for potential attendees based on the availability of each the potential attendees at a time period associated with the current location of the event object.

Data collector 420 may receive user input that identifies potential attendees to associate with the event object (e.g., event object 110) and retrieve scheduling data for each potential attendee. In some implementations, user input may be received directly by data collector 420 or indirectly through object controller 410. In one implementation, data collector 420 may retrieve scheduling data for each potential attendee by requesting information from a service provider (using, e.g., communication interface 330, to contact a server of the service provider) that has access to scheduling data for each potential attendee. In another implementation, scheduling information may be retrieved using peer-to-peer sharing techniques with one or more other devices. Data collector 420 may retrieve the scheduling information for each of the potential attendees and store the information (e.g., in memory 310) for object controller 410 to use in calculating attendee availability. In one implementations, data collector 420 may retrieve schedule information for a particular time period (e.g., one week or one month from the current time) to conserve memory use in device 200.

GUI data 430 may include information that may be used by object controller 410 to compile graphics for event scheduling interface 100. GUI data 430 may include, for example, user preferences, images and/or templates. User preferences may include, for example, format preferences for the calendar/timeline arrangement, such as font/icon sizes, viewable time-spans (e.g., one day, multiple days, weeks, etc.), images, and/or display size. Images may include, for example, images representing potential attendee(s), background images for templates, skins (e.g., custom graphical appearances), etc. Templates may include formats for event scheduling interface 100 to which particular scheduling information may be supplied for presentation on a display (e.g., display 230).

Peripheral applications 440 may include applications that may receive, generate, or manipulate schedule information for one or more potential attendees. In some implementations, peripheral applications 430 may be stored within a memory (e.g., memory 310) of device 200 and/or stored on a remote device that can be accessed over a network. Peripheral applications 440 may include, for example, data conversion applications to translate scheduling information into a format useable by event scheduling interface 100. Peripheral applications 440 may also include any application from which scheduling information or potential attendee information may be obtained, such as a telephone application, a text-messaging application, an email application, an instant messaging (IM) application, a calendar application, a multimedia messaging service (MMS) application, a short message service (SMS) application, an image viewing application, a camera application, an organizer application, a video player, an audio application, a GPS application, etc.

Although FIG. 4 shows exemplary functional components of device 200, in other implementations, device 200 may contain fewer, different, differently arranged, or additional functional components than depicted in FIG. 4. In still other implementations, a functional component of device 200 may perform one or more tasks described as being performed by another functional component of device 200.

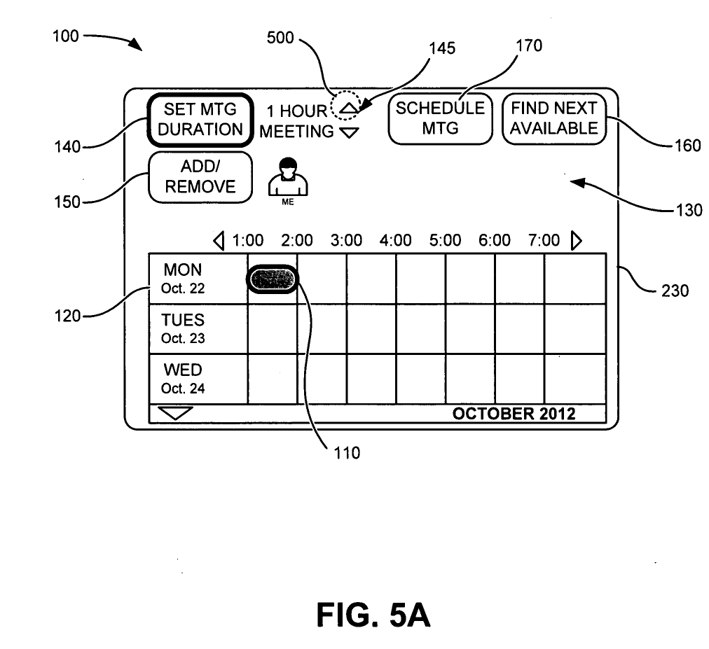

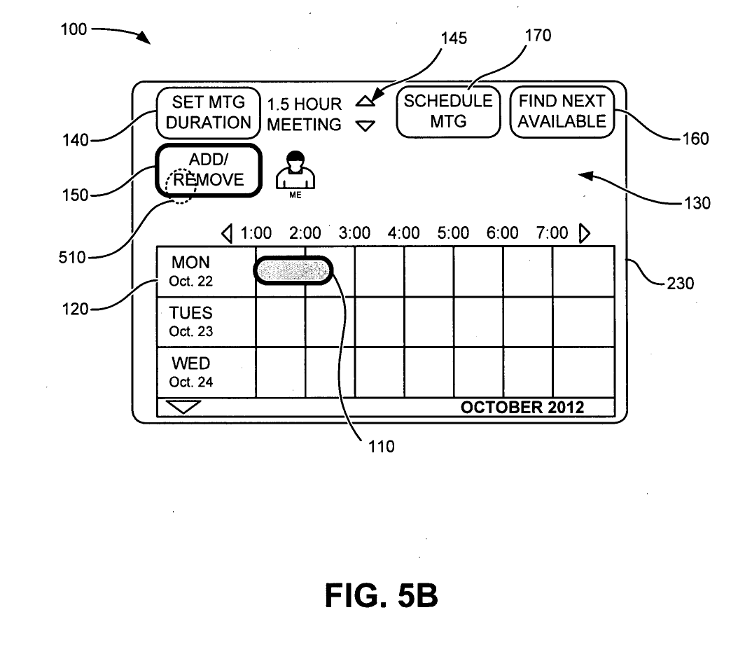

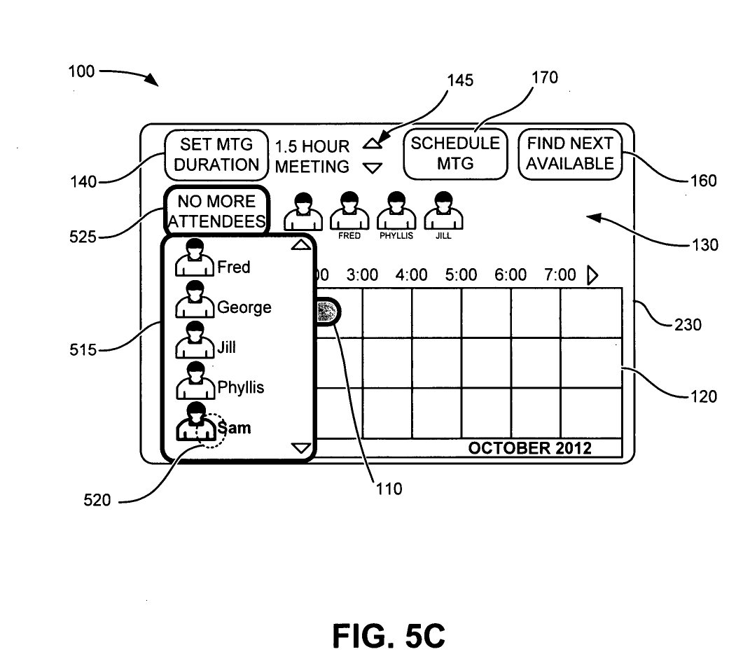

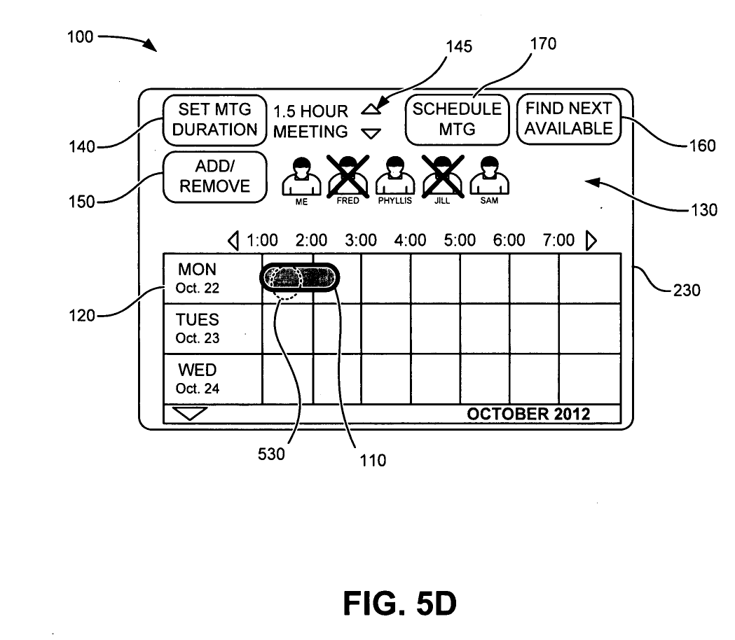

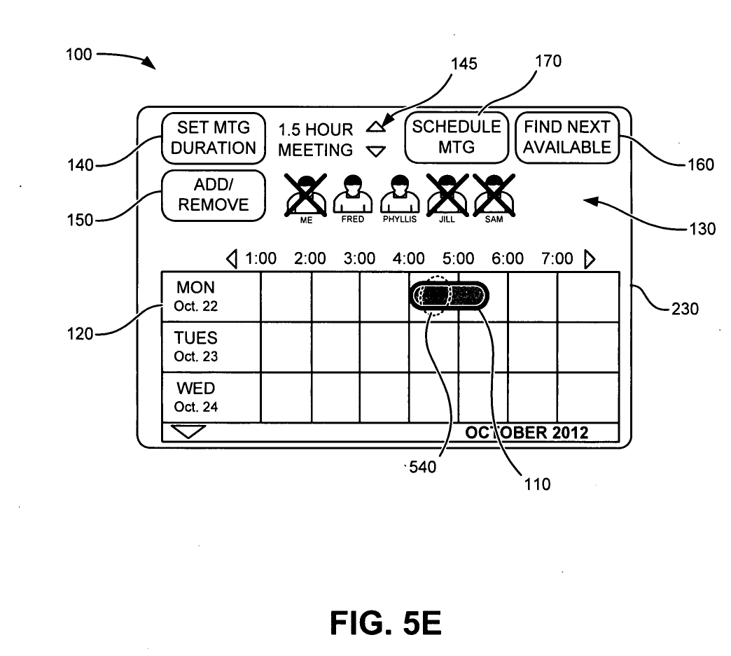

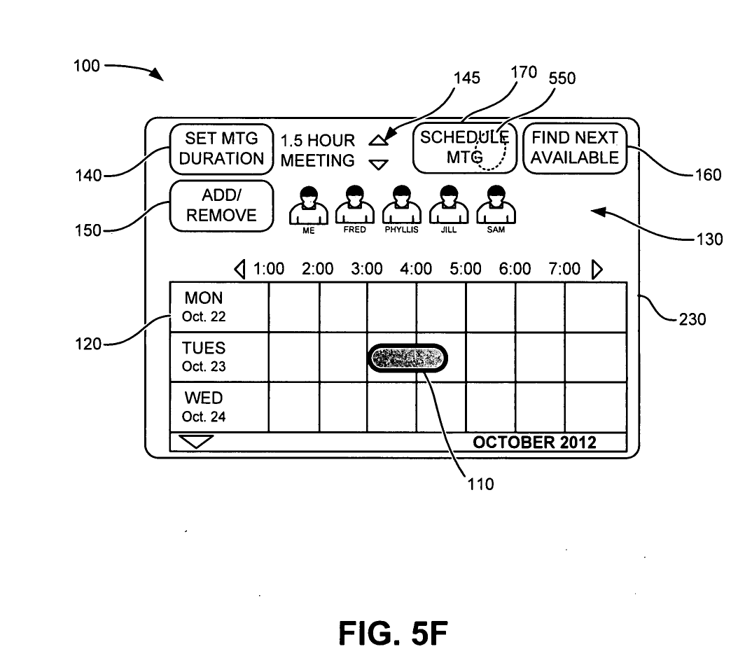

FIGS. 5A-5F illustrate exemplary scheduling operations capable of being performed by a device, such as device 200, using event scheduling interface 100. In FIGS. 5A-5F, event scheduling interface 100 is shown as receiving a sequence of user inputs over a period of time. As illustrated, event scheduling interface 100 may include event object 110, calendar 120, representations 130, set meeting duration icon 140, add/remove attendee icon 150, find next available icon 160, and schedule meeting icon 170. Event object 110, calendar 120, representations 130, set meeting duration icon 140, add/remove attendee icon 150, find next available icon 160, and schedule meeting icon 170 may include the features described above in connection with, for example, FIG. 1. Assume, in the example of FIGS. 5A-5F, the user intends to schedule a 1.5 hour meeting for five people (including the user).

FIG. 5A provides a view of an exemplary event scheduling interface 100 as initially presented to a user. Event scheduling interface 100 may be initially displayed, for example, on a display (e.g., display 230) of device 200 in response to a user selecting an option from a menu (e.g., “plan a meeting”) or selecting a control button (e.g., one of control buttons 240) when a particular application is being used. Calendar 120 may be presented to show time periods immediately following the current time (e.g., 1:00 on Monday, October 22^{nd}). In one implementation, event object 110 may be presented with a default duration (e.g., 1 hour) and initially be positioned at the first presented time period. In another implementation, event object 110 may be initially positioned at the earliest time period (with respect to a current time period) for which no conflicts exist for the currently list of potential attendees. A representation 130 for the user (e.g., “ME”) may also be included as a default potential attendee.

Because a 1.5 hour meeting is desired (for the present example), user input 500 may be applied to incremental control 145 to increase the duration of meeting object 110. In other implementations, the duration of meeting object 110 may be altered using set duration meeting icon 140, which may open another window to provide controls/settings for event object 110.

As shown in FIG. 5B, the size of event object 110 has been increased to span a 1.5 hour time period, in response to user input 500 of FIG. 5A. User input 510 may be applied to select add/remove attendee icon 150, so that the user may add potential attendees for the meeting.

As shown in FIG. 5C, in response to user input 510 of FIG. 5B, a contact list window 515 may be displayed and add/remove attendee icon 150 may be replaced by no more attendees icon 525. The user may select potential attendees for the meeting from the list in contact list window 515. In FIG. 5C, potential attendees “FRED,” “PHYLLIS,” and “JILL” have been added by the user and representations 130 have been added for each selected contact. User input 520 may be applied to select another potential attendee, “SAM.” When all potential attendees have been added, user input to select no more attendees icon 525 may remove contact window list 515 from view in event scheduling interface 100.

Referring to FIG. 5D, event object 110 may now be associated with the schedules of potential attendees, the user (e.g., “ME”), “FRED,” “PHYLLIS,” “JILL,” and “SAM,” as indicated by representations 130. Based on the location of event object 110 on calendar 120, the schedules of each potential attendee may be reviewed for availability. Representations 130 for each potential attendee may be marked to indicate availability (or unavailability) for the currently selected time-slot as indicated by the position of event object 110. Availability may be indicated, for example, by color-coding (e.g., green for available and red for unavailable), symbols (e.g., check marks and/or cross-outs), faded/bright images, etc. As shown in FIG. 5D, representations 130 for two potential attendees, “FRED” and “JILL,” are shown as unavailable by an “X” overlaid on the respective representations 130. Thus, user input 530 may be applied to event object 110 to relocate the event object 110.

Referring to FIG. 5E, event object 110 is shown having been dragged from its original location on calendar 120 (e.g., starting at 1:00 on Monday, October 22^{nd}) to starting at 4:00 on Monday, October 22^{nd}. As shown in FIG. 5E, representations 130 for three potential attendees, the user (e.g., “ME”), “JILL,” and “SAM” are shown as unavailable by an “X” overlaid on the respective representations 130. Thus, user input 540 may be applied to event object 110 to relocate the event object 110.

Referring to FIG. 5F, event object 110 is shown having been dragged from starting at 4:00 on Monday, October 22^{nd} in FIG. 5E to 3:00 on Tuesday, October 23^{rd}. In another implementation, the location of event object 110 may be determined by a user selecting find next available icon 160. Selection of find next available icon 160 may cause device 200 to look forward in time from the current location of the event object 110 to identify the next available time period that has no conflicts for any of the potential attendees. As shown in FIG. 5F, all potential attendees are indicated to be available by their respective representations 130. Seeing no conflicts, user input 550 may be applied to schedule meeting icon 170 to schedule the meeting. When schedule meeting icon 170 is selected, device 200 may launch one or more peripheral applications (e.g., peripheral applications 440) that may be used to send meeting announcements to the potential attendees previously identified by the user. For example, in one implementation, device 200 may automatically prepare a email addressed to each of the potential attendees.

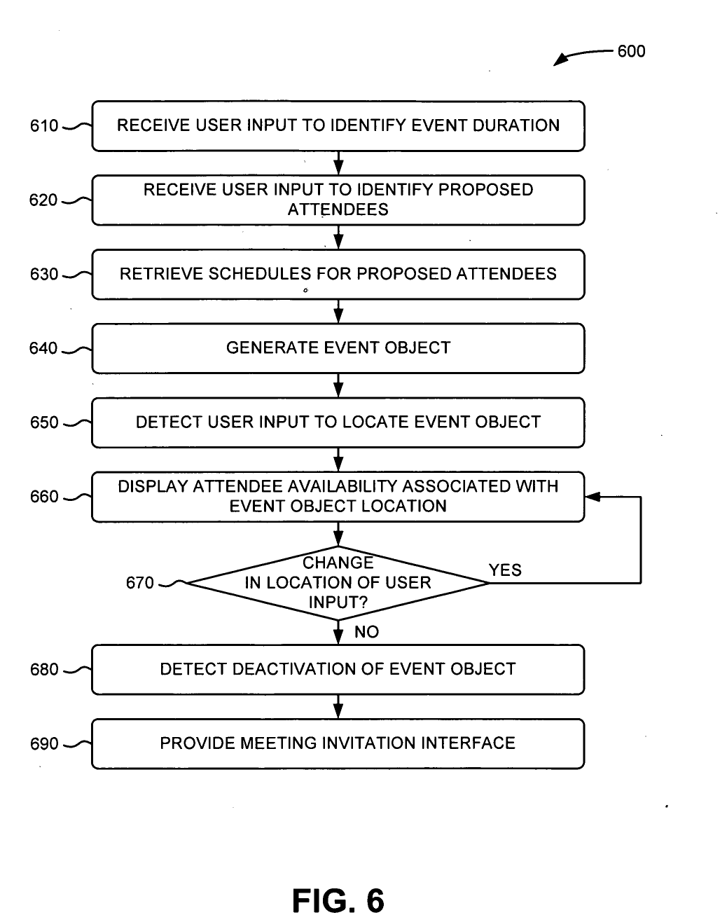

FIG. 6 depicts a flow chart of an exemplary process 600 for providing an event scheduling interface (e.g., event scheduling interface 100) according to implementations described herein. In one implementation, process 600 may be performed by device 200.

As illustrated in FIG. 6, process 600 may begin with receiving user input to identify an event duration (block 610) and receiving user input to identify proposed attendees for the event (block 620). For example, as described above with respect to FIGS. 5A-5B, device 200 (e.g., object controller 410) may identify a touch on a touch-sensitive display that corresponds to the location of a set meeting duration icon (e.g., set meeting duration icon 140) or an incremental control (e.g., incremental controls 145). Also, as described above with respect to FIGS. 5B-5C, device 200 (e.g., object controller 410) may identify a touch on a touch-sensitive display that corresponds to the location of an attendee selector icon (e.g., add/remove attendee icon 150). In other implementations, default information may be provided for the event duration and/or proposed attendees, where the default information may be altered by user input. In other implementations, schedule information for potential attendees may also include schedule information for facility schedules, such as conference rooms or other meeting locations.

In another exemplary implementation where a touch-screen is not used, device 200 may identify a particular user input associated with the location of a cursor (guided, e.g., by the mouse, touch-panel, or other input device) on the event scheduling interface 100. In still another exemplary implementation, device 200 may identify user input for a particular icon/command associated with event duration or proposed attendees based on the direction from a keypad or control button, such as an arrow, trackball, or joystick.

Schedule information for the proposed attendees may be retrieved (block 630). For example, device 200 (e.g., data collector 420) may retrieve scheduling data for each potential attendee identified by activities in block 620. Data collector 420 may retrieve scheduling data for each potential attendee by requesting information from a service provider (using, e.g., communication interface 330 to contact a server of the service provider) or from one or more devices associated with the potential attendees. For example, a calendar program for a potential attendee may store information of previously scheduled events that may preclude availability of the potential attendee during particular time periods. Information from the calendar program may be retrieved directly (or indirectly) by device 200.

An event object may be generated (block 640). For example, device 200 (e.g., object controller 410) may create an event object (e.g., event object 110) for the selected event duration that is linked to the scheduling data for each potential attendee. In one implementation, the event object may be presented as a graphical object that can be moved in time along a calendar representation (e.g., calendar 120). The event object may include potential attendee dependencies that can register potential attendee availability (or unavailability) for the time-period defined by the location/duration of the event object.

User input to locate the event object may be detected (block 650). For example, as described above with respect to FIGS. 5D-5E, device 200 (e.g., object controller 410) may identify user input to drag the event object to a location on the calendar representation. In one implementation, user input may be in the form of a touch on a touch-sensitive display (e.g., display 230). In other implementations, user input may be provided via guided cursor or via a command key.

Attendee availability associated with the location of the event object may be displayed (block 660). For example, device 200 (e.g., object controller 410) may provide a representation (e.g., representation 130) of each potential attendee to indicate availability/unavailability of each attendee for the time period defined by the location/duration of the event object. As described above with respect to FIGS. 5D-5F, indications of attendee availability/unavailability may be presented using any of a variety of graphical techniques to allow a user to visualize the availability/unavailability of each potential attendee.

It may be determined if there is a change of location of the user input for the event object (block 670). For example, device 200 may identify a change in the touch location, the cursor location, or the control button direction that corresponds to a movement of event object 110. As another example, device 200 may identify user input to a find next available icon (e.g., find next available icon 160) that may cause device 200 to automatically identify the next available time period for which no conflicts exist and move the event object to the corresponding location. If a change of location of the user input for the event object is detected (block 670—YES), process 600 may return to block 660 to display attendee availability associated with the location of the event object.

If no change of location of the user input for the event object is detected (block 670 NO), deactivation of the event object may be detected. For example, device 200 may eventually detect removal of the user input from the event object. Removal of the user input may include, for example, removal of the touch from the touch sensitive display, release of a mouse-click associated with a cursor, or pressing of a dedicated control button. In response the detected deactivation, device 200 may continue to display the event object at its most recent location and the representation of each potential attendee to indicate availability/unavailability of each attendee for the time period defined by the location/duration of the event object.

A meeting invitation interface may be provided (block 690). For example, once a user identifies a particular time that is acceptable (e.g., has no attendee conflicts or has an acceptable quorum) for the planned event, user input may be provided to open a meeting invitation interface (e.g., schedule meeting icon 170). In one implementation, the meeting invitation interface may launch one or more peripheral applications (e.g., peripheral applications 440) that may be used to send meeting announcements to the potential attendees previously identified by the user. For example, device 200 may launch an email application and provide a draft email with the address of each potential attendee and/or the meeting time information.

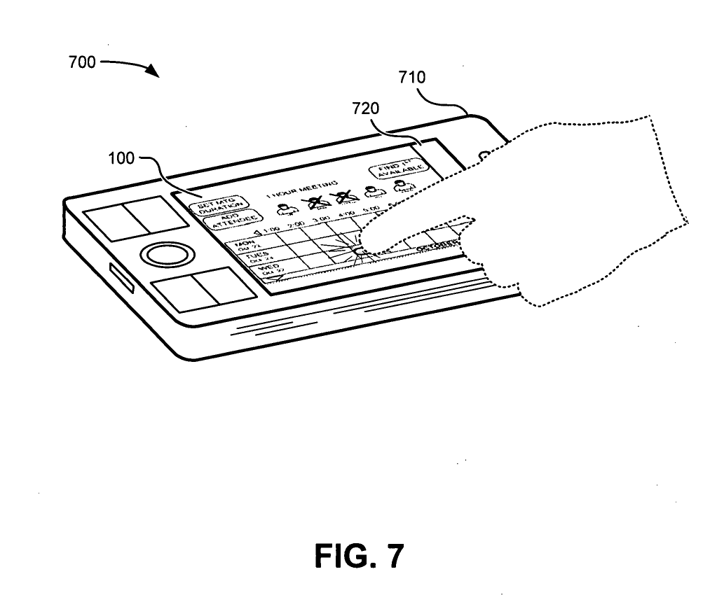

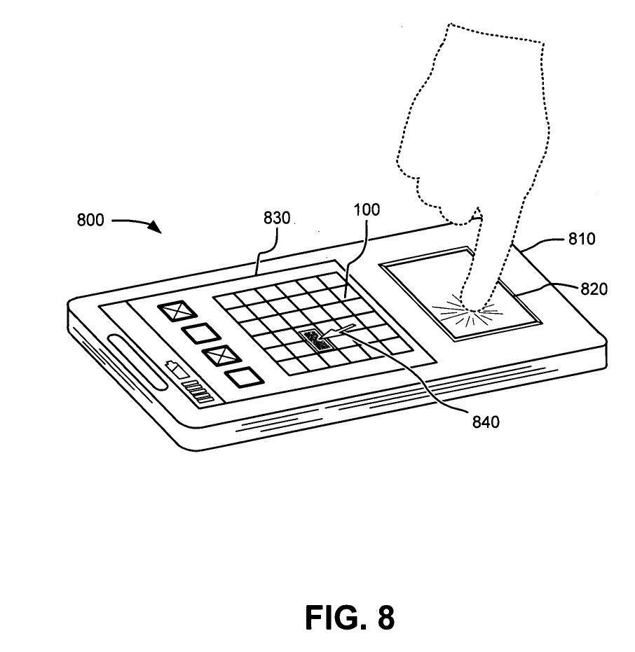

FIGS. 7 and 8 provide illustrations of exemplary user input for an event scheduling interface on a variety of devices. FIG. 7 provides an illustration of an exemplary implementation of user input for an event scheduling interface 100 on a device 700 with a touch-sensitive display. Referring to FIG. 7, device 700 may include housing 710 and a touch-sensitive display 720. Other components, such as control buttons, a microphone, connectivity ports, memory slots, and/or speakers may be located on device 700, including, for example, on a rear or side panel of housing 710. Although FIG. 7 shows exemplary components of device 700, in other implementations, device 700 may contain fewer, different, differently arranged, or additional components than depicted in FIG. 7.

Touch-sensitive display 720 may include a display screen integrated with a touch-sensitive overlay. In an exemplary implementation, touch-sensitive display 720 may include a capacitive touch overlay. An object having capacitance (e.g., a user's finger) may be placed on or near display 720 to form a capacitance between the object and one or more of the touch sensing points. The touch sensing points may be used to determine touch coordinates (e.g., location) of the touch. The touch coordinates may be associated with a portion of the display screen having corresponding coordinates, including coordinates for a multi-button menu icon. In other implementations, different touch screen technologies may be used.

Touch-sensitive display 720 may include the ability to identify movement of an object as the object moves on the surface of touch-sensitive display 720. As described above with respect to, for example, FIGS. 5A-5F, device 700 may display on touch-sensitive display 720 an event scheduling interface that accepts user input to an event object (e.g., event object 110). In the implementation shown in FIG. 7, event object 110 may be touched and dragged along a calendar representation while attendee availability associated with the location of the event object is displayed based on the current location of the event object.

FIG. 8 provides an illustration of an exemplary implementation of user input for event scheduling interface 100 on a device 800 with a touch panel separate from a display. Device 800 may include housing 810, touch panel 820, and display 830. Other components, such as control buttons, a keypad, a microphone, a camera, connectivity ports, memory slots, and/or speakers, may be located on device 800, including, for example, on a rear or side panel of housing 810. Although FIG. 8 shows exemplary components of device 800, in other implementations, device 800 may contain fewer, different, differently arranged, or additional components than depicted in FIG. 8.

FIG. 8 illustrates touch panel 820 being separately located from display 830 on housing 810. Touch panel 820 may include any resistive touch panel technology or other technology providing the ability to register a set of touch coordinates. User input on touch panel 820 may be associated with display 830 by, for example, movement and location of a cursor 840. User input on touch panel 820 may be in the form of the touch of nearly any object, such as a body part (e.g., a finger, as shown) or a pointing device (e.g., a stylus, pen, etc.).

Touch panel 820 may be operatively connected with display 830 to allow the combination of touch panel 820 and display 830 to be used as an input device. Touch panel 820 may include the ability to identify movement of an object as the object moves on the surface of touch panel 820. As described above with respect to, for example, FIGS. 5A-5F, device 800 may display on display 830 an event scheduling interface 100 that accepts (via touch panel 820) user input to an event object (e.g., event object 110). In the implementation shown in FIG. 8, event object 110 may be selected by positioning cursor 840 over the event object and, for example, double-touching touch pad 820 to select the event object. The selected event object may then be dragged along a calendar representation while attendee availability associated with the location of the event object is displayed based on the current location of the event object. The event object may be deactivated by, for example, double-touching the touch pad 820.

Systems and/or methods described herein may include receiving a user input to associate two or more contacts with an event object, retrieving scheduling information for each of the two or more contacts, and presenting, on a display, a calendar presentation and the event object located within the calendar presentation. Systems and/or methods described herein may further include receiving a user input to move the event object to multiple locations within the calendar presentation, where each of the locations of the event object within the calendar presentation is associated with a different time period, and presenting an indication of the availability of each of the two or more contacts for each time period associated with the position of the event object.

The foregoing description of implementations provides illustration and description, but is not intended to be exhaustive or to limit the invention to the precise form disclosed. Modifications and variations are possible in light of the above teachings or may be acquired from practice of the invention.

For example, while implementations have been described primarily in the context of a mobile device (such as a radiotelephone, a PCS terminal, or a PDA), in other implementations the systems and/or methods described herein may be implemented on other computing devices such as a laptop computer, a personal computer, a tablet computer, an ultra-mobile personal computer, or a home gaming system.

Also, while a series of blocks has been described with regard to FIG. 6, the order of the blocks may be modified in other implementations. Further, non-dependent blocks may be performed in parallel.

It will be apparent that aspects described herein may be implemented in many different forms of software, firmware, and hardware in the implementations illustrated in the figures. The actual software code or specialized control hardware used to implement these aspects is not limiting of the invention. Thus, the operation and behavior of these aspects were described without reference to the specific software code—it being understood that software and control hardware may be designed to implement these aspects based on the description herein.

Further, certain portions of the invention may be implemented as “logic” that performs one or more functions. This logic may include hardware, such as an application specific integrated circuit or a field programmable gate array, or a combination of hardware and software.

Even though particular combinations of features are recited in the claims and/or disclosed in the specification, these combinations are not intended to limit the disclosure of the invention. In fact, many of these features may be combined in ways not specifically recited in the claims and/or disclosed in the specification.

No element, act, or instruction used in the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A computing device-implemented method, comprising:
receiving a user input to associate schedules of two or more potential attendees with an event object;
displaying, on a screen of the computing device, the event object, where the event object is positioned to be associated with a first time period within a calendar representation;
displaying, on the screen of the computing device, a representation of an availability of the two or more potential attendees for the first time period;
receiving a user input to reposition the event object to be associated with a second time period within the calendar representation; and
displaying, on the screen of the computing device, a representation of an availability of the two or more potential attendees for the second time period.

2. The computing device-implemented method of claim 1, further comprising:
receiving user input to define an event duration for the event object.

3. The computing device-implemented method of claim 1, further comprising:
receiving a user input to schedule a meeting for the two or more potential attendees at the second time period; and
automatically generating an invitation for the two or more potential attendees.

4. The computing device-implemented method of claim 1, further comprising:
retrieving scheduling information for each of the two or more potential attendees.

5. The computing device-implemented method of claim 4, where the scheduling information for each of the two or more potential attendees is retrieved from a remote server.

6. The computing device-implemented method of claim 4, where the scheduling information for each of the two or more potential attendees is retrieved from a peer device.

7. The computing device-implemented method of claim 1, where the user input to reposition the event object is a touch on a touch sensitive display.

8. The computing device-implemented method of claim 1, where the user input to reposition the event object includes one of:
selecting the event object using an input device guiding a cursor, or
activating the event object using a control button on the computing device.

9. The computing device-implemented method of claim 1, where the first time period is the closest period in time, to a current time period, that present no conflicts for the two or more potential attendees.

10. The computing device-implemented method of claim 1, where receiving the user input to reposition the event object to be associated with the second time period comprises:
receiving a user input to a find next available icon, and
automatically identifying the second time period, that is the closest period in time to the first time period, that present no conflicts for the two or more potential attendees.

11. A device, comprising:
a memory to store a plurality of instructions;
a touch-sensitive display;
a communications interface; and
a processor to execute instructions in the memory to:
receive a user input to associate two or more items with an event object,
retrieve, using the communications interface, scheduling information for each of the two or more items,
display, on the touch-sensitive display, a calendar presentation and the event object, the event object positioned so as to be associated with a first time period within the calendar presentation,
display, on the touch-sensitive display, an indication of an availability each of the two or more items for the first time period,
receive a user input to reposition the event object so as to be associated with a second time period within the calendar presentation, and
display, on the touch-sensitive display, an indication of an availability each of the two or more items for the second time period.

12. The device of claim 11, where the processor further executes instructions in the memory to:
receive user input to define an event duration for the event object.

13. The device of claim 11, where the processor further executes instructions in the memory to:
receive a user input to schedule a meeting for the two or more items at the second time period; and
generate an invitation for the two or more items.

14. The device of claim 11, where the scheduling information for each of the two or more items is retrieved from a remote server.

15. The device of claim 11, where the scheduling information for each of the two or more items is retrieved from a peer device.

16. The device of claim 11, where the first time period is the closest period in time relative to a current time that present no conflicts for the two or more items.

17. A device, comprising:
a memory to store a plurality of instructions;
a display; and
a processor to execute instructions in the memory to:
receive a user input to associate two or more contacts with an event object,
retrieve scheduling information for each of the two or more contacts,
present, on the display, a calendar presentation and the event object located within the calendar presentation,
receive a user input to move the event object to a plurality of locations within the calendar presentation, where each of the locations of the event object within the calendar presentation is associated with a different time period, and
present an indication of an availability of each of the two or more contacts for each time period associated with the position of the event object.

18. The device of claim 17, where the display is a touch sensitive display, and where the user input is a touch of the event object on the touch sensitive display.

19. The device of claim 17, where the processor further executes instructions in the memory to:
receive a user input to define a duration for the event object.

20. The device of claim 17, where the indication of the availability of each of the two or more contacts is presented in real-time.

21. A device, comprising:
means for receiving schedules for a plurality of contacts;
means for associating the schedules with an event object;
means for displaying the event object within a time-based representation, where a location of the event object within the time-based representation is associated with a particular time period;
means for receiving user input to move the event object within the time-based representation; and
means for presenting an indication of the availability of each of the plurality of contacts for each time period associated with the position of the event object.

22. The device of claim 21, further comprising:
means for identifying a time period that is the closest period in time, to a current time period, that present no conflicts for the plurality of contacts.
